(19) United States
(12) Patent Application Publication
(10) Pub. No.: US 2022/0239211 A1
(43) Pub. Date: Jul. 28, 2022

(54) HORIZONTAL LINEAR VIBRATING MOTOR

(71) Applicant: AUSP Korea Co.,Ltd., Incheon (KR)

(72) Inventors: Jin-Seon KANG, Incheon (KR); Gyo-Suk CHOI, Incheon (KR); Hyun-Jun PARK, Incheon (KR); Hwa-Sic KIM, Gyeonggi-do (KR); Jong-Ki LEE, Incheon (KR)

(21) Appl. No.: 17/491,211

(22) Filed: Sep. 30, 2021

(30) Foreign Application Priority Data
Jan. 26, 2021 (KR) 10-2021-0010575

(51) Int. Cl. H02K 33/18; H02K 11/01

(52) U.S. Cl. CPC H02K 33/18; H02K 11/0141

(57) ABSTRACT

The present disclosure relates to a horizontal linear vibrating motor, and more particularly, to a horizontal linear vibrating motor which has a smaller size than existing liner motors so as to be mounted on a small-size wearable watch, smart band or the like, while providing a strong vibration.

### CROSS-REFERENCE TO RELATED APPLICATION

The present application claims priority under 35 U.S.C. § 119(a) to Korean patent application number 10-2021-0010575 filed on Jan. 26, 2021, the entire disclosure of which is incorporated by reference herein.

### BACKGROUND

### 1. Technical Field

The present disclosure relates to a horizontal linear vibrating motor, and more particularly, to a horizontal linear vibrating motor which has a smaller size than existing liner motors so as to be mounted on a small-size wearable watch, smart band or the like, while providing a strong vibration.

### 2. Related Art

Recently, the rapid development of wireless communication technology has gradually reduced the sizes and weights of mobile communication devices. Following such a trend for the reduction in size and weight, the integration degree and functions of parts, which are mounted in a mobile communication device and include mechanical equipment, IC chips and circuits, have been improved. Thus, the sizes and shapes of the parts need to be enhanced, in order to make better use of the space.

Furthermore, according the above-described trend, much research is also being conducted on a flat vibrating motor which is mounted in a mobile communication device and serves to notify the receipt of a message through vibration with no sound.

Early models of a vibrating motor mounted in a mobile communication device are mostly rotary vibrating motors each having a stator and rotor as basic components. Such a rotary vibrating motor has generated vibration by supporting and rotating the rotor on the shaft, with a shaft fixed to a bracket of the stator. Furthermore, in order to improve the vibration force, the volume of the rotor has been increased, or the number of revolutions has been raised. However, there was a limitation in reducing the size of the rotary vibrating motor due to a structural problem thereof, and the rotary vibrating motor had many difficulties in generating high vibration, and could not guarantee a lifetime equal to or longer than a predetermined time.

A horizontal vibrating motor using a vibrating actuator has been developed by improving such problems. The horizontal vibrating motor may have a longer lifetime than the rotary vibrating motor, and can not only overcome a limitation in size, but also acquire high response speed. Thus, the horizontal vibrating motor is widely used in recent years.

Furthermore, the horizontal vibrating motor has a structure in which shock caused by a vibrating body is not applied to internal parts thereof, which makes it possible to increase the lifetime of the vibrating motor, and to manufacture an enhanced vibrating motor capable of improving the vibrating force of the vibrating body. Therefore, there is a continuous need for the development of a vibrating motor whose durability and vibrating force are further improved.

[Related Art Document]

[Patent Document]

(Patent Document 1) Korean Patent Application Publication No. 10-2010-0073301 (published on Jul. 1, 2010)

### SUMMARY

Various embodiments are directed to a horizontal linear vibrating motor which can improve the vibration characteristic by maximizing the concentration level of electromagnetic fields, has a smaller size than existing linear motors so as to be mounted on a small-size wearable watch, smart band or the like, while providing a strong vibration.

In an embodiment, a horizontal linear vibrating motor may include: a bracket 100 form the exterior of the horizontal linear vibrating motor, and configured to fix an FPCB 200, and shield leakage flux; the FPCB 200 seated on the top of the bracket 100 and configured to supply an external voltage to a coil 300; the coil 300 provided on the FPCB 200, and configured to generate an electromagnetic field according to an external signal, and amplify horizontal vibration through an interaction with a magnet 400; the magnet 400 provided as a permanent magnet, fixed to a plate 600, and configured to generate a magnetic field, and cause the weight 500 to horizontally vibrate from side to side, through an interaction with the magnetic field of the coil 300; the weight 500 connected to a spring 700, configured to amplify vibration using the weight thereof and decide a resonance frequency, and having the plate 600 fixed thereto; the plate 600 fixed to the weight 500, coupled to the magnet 400, and configured to form a magnetic field closed loop to concentrate magnetic fields; the spring 700 connected to a case 800 and the weight 500, and configured to amplify vibration, and decide the resonance frequency; the case 800 forming the exterior of the horizontal linear vibrating motor, and configured to protect the weight 500, fix the spring 700, and shield leakage flux; and a support 900 configured to fix the spring 700. Thus, the horizontal linear vibrating motor can improve an electromagnetic field force so as to be driven at a high response speed and wide frequency band.

In accordance with the embodiment of the present disclosure, the horizontal linear vibrating motor can improve an electromagnetic field force so as to be driven at a high response speed and wide frequency band.

Furthermore, the horizontal linear vibrating motor can maximize the concentration level of magnetic fields, thereby improving the vibration characteristic.

Furthermore, the horizontal linear vibrating motor has a smaller size than existing liner motors so as to be mounted on a small-size wearable device, while providing a strong vibration.

### BRIEF DESCRIPTION OF THE DRAWINGS

FIG. 1 is an exploded perspective view of a horizontal linear vibrating motor in accordance with an embodiment of the present disclosure.

FIG. 2A is a transverse cross-sectional view of the horizontal linear vibrating motor in accordance with the embodiment of the present disclosure.

FIG. 2B is a longitudinal cross-sectional view of the horizontal linear vibrating motor in accordance with the embodiment of the present disclosure.

FIG. 3 is a front and side view illustrating a spring which is a main part of the horizontal linear vibrating motor in accordance with the embodiment of the present disclosure.

FIG. 4 is a diagram illustrating magnetic field distributions and magnetic field flows of a bracket and a case of the horizontal linear vibrating motor in accordance with the embodiment of the present disclosure.

FIG. 5 is a diagram illustrating distributions and magnetic flux densities of a non-magnetic material and a magnetic material, which are applied to the bracket and case of the horizontal linear vibrating motor in accordance with the embodiment of the present disclosure.

FIG. 6A is a transverse cross-sectional view illustrating a horizontal linear vibrating motor in accordance with another embodiment of the present disclosure.

FIG. 6B is a longitudinal cross-sectional view illustrating the horizontal linear vibrating motor in accordance with the another embodiment of the present disclosure.

FIG. 7A is a longitudinal cross-sectional view illustrating the state of a horizontal linear vibrating motor in accordance with still another embodiment of the present disclosure, before a stopper type damper is operated.

FIG. 7B is a longitudinal cross-sectional view illustrating the state of the horizontal linear vibrating motor in accordance with the still another embodiment of the present disclosure, after the stopper type damper is operated.

### DETAILED DESCRIPTION

Hereafter, the present disclosure can be modified in various manners and embodied in various manners, and specific embodiments are illustrated in the accompanying drawings and will be described in detail with the reference to the drawings. However, the present disclosure is not limited to the specific embodiments, and it should be understood that the present disclosure includes all modifications, equivalents and substitutions without departing from the spirit and technical scope of the present disclosure.

The present embodiments are provided to describe the present disclosure in more detail to those skilled in the art to which the present disclosure pertains. Therefore, the shapes of components in each of the drawings may be exaggerated to more clearly emphasize the descriptions. Moreover, when the present disclosure is described, detailed descriptions related to well-known arts will be ruled out in order not to unnecessarily obscure subject matters of the present disclosure.

The terms such as first and second may be used to describe various components, but only used to distinguish one component from another component.

The terms used in the present disclosure are used only to describe a specific embodiment, and do not limit the present disclosure. The terms of a singular form may include plural forms unless referred to the contrary.

In the present disclosure, the meaning of “include” or “have” specifies a property, a number, a step, a process, an element, a component, or combinations thereof, but does not exclude the presence or addition of one or more other properties, numbers, steps, processes, elements, components, or combinations thereof.

First, the present disclosure relates to a horizontal linear vibrating motor which may include one or more of a bracket 100, an FPCB 200, a coil 300, a magnet 400, a weight 500, a plate 600, a spring 700, a case 800 and a support 900.

Hereafter, preferred embodiments of the present disclosure will be described in more detail with reference to the accompanying drawings.

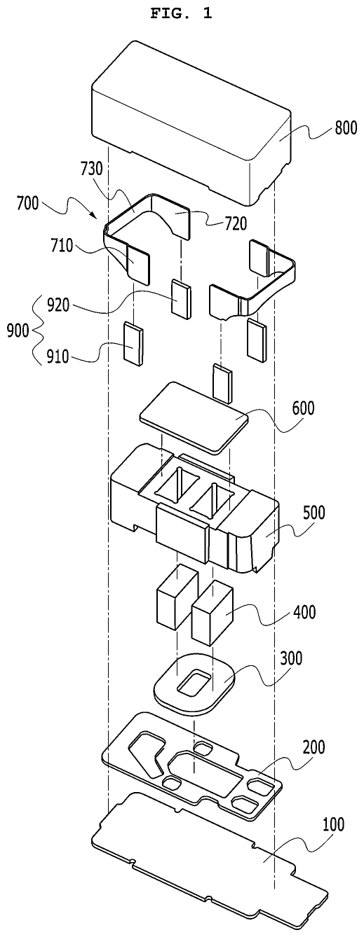

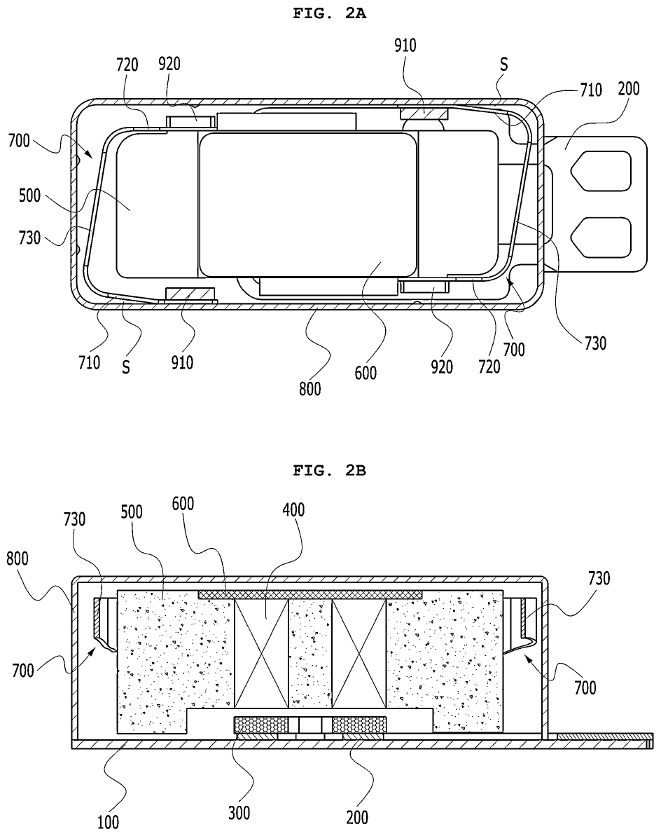

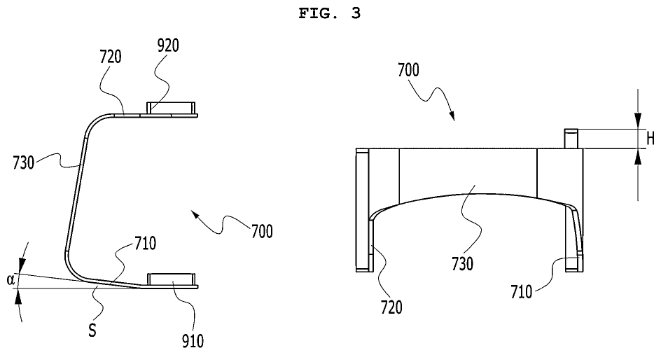

FIG. 1 is an exploded perspective view of a horizontal linear vibrating motor in accordance with an embodiment of the present disclosure, FIG. 2A is a transverse cross-sectional view of the horizontal linear vibrating motor in accordance with the embodiment of the present disclosure, FIG. 2B is a longitudinal cross-sectional view of the horizontal linear vibrating motor in accordance with the embodiment of the present disclosure, and FIG. 3 is a front and side view illustrating a spring which is a main part of the horizontal linear vibrating motor in accordance with the embodiment of the present disclosure.

The horizontal linear vibrating motor in accordance with the embodiment of the present disclosure includes a bracket 100, an FPCB 200, a coil 300, a magnet 400, a weight 500, a plate 600, a spring 700, a case 800 and a support 900. The bracket 100 forms the exterior of the horizontal linear vibrating motor, and is configured to fix the FPCB 200 and shield leakage flux. The FPCB 200 is seated on the bracket 100 and configured to supply an external voltage to the coil 300. The coil 300 is provided on the FPCB 200 and configured to generate an electromagnetic field according to an external signal and amplify horizontal vibration through an interaction with the magnet 400. The magnet 400 is provided as a permanent magnet, fixed to the plate 600, and configured to generate a magnetic field, and cause the weight 500 to horizontally vibrate from side to side through an interaction with the magnetic field of the coil 300. The weight 500 has the plate 600 fixed thereto, and is connected to the spring 700, and configured to amplify vibration using the weight thereof, and decide a resonance frequency. The plate 600 is fixed to the weight 500 and coupled to the magnet 400 and configured to form a magnetic field closed loop to concentrate magnetic fields. The spring 700 is connected to the case 800 and the weight 500 and configured to amplify vibration and decide the resonance frequency. The case 800 forms the exterior of the horizontal linear vibrating motor, and is configured to protect the weight 500, fix the spring 700, and shield leakage flux. The support 900 is configured to fix the spring 700.

The spring 700 includes a first spring piece 710 provided at the front thereof and a second spring piece 720 provided at the rear thereof so as to maintain a predetermined distance from the first spring piece 710. As the first and second spring pieces 710 and 720 are connected to each other through a third spring piece 730, the spring 700 has a U-shaped structure as a whole. Furthermore, the first and second spring pieces 710 and 720 are arranged on the left and right sides of the weight 500 in a longitudinal direction thereof, such that the spring 700 has a bilaterally symmetrical structure. This is in order to fix the first and second spring pieces to the weight 500 and the case 800 such that the vibration balance can be uniformly maintained.

The first spring piece 710 is fixed to the inner surface of the case 800 by a first support 910, and the second spring piece 720 provided at the rear thereof is fixed to the outer surface of the weight 500 by a second support 920.

As illustrated on the left side of the FIG. 3, the first spring piece 710 is bent at a predetermined angle α toward the weight 500 from an end of the first support 910, such that a straight space S is formed to enable straight movement.

The angle α may be set to 5° or more, in order to prevent the weight 500 from interfering with the case 800, while the weight 500 linearly reciprocates. That is, when the angle α is equal to or less than 5°, the range in which the first spring piece 710 is moved around the first support 910 is narrowed to extremely limit the movement of the weight 500. In this case, the amount of vibration is reduced. This is in order to secure a sufficient resonance frequency despite the reduction in size.

As illustrated on the right side of FIG. 3, the first support 910 may protrude from the top of the first spring piece 710 so as to have a predetermined height H. Thus, when the first support 910 is assembled to the case 800, the predetermined height may be maintained.

The top of the third spring piece 730 has a planar shape, and the bottom of the third spring piece 730 has an arch shape, such that vibration can smoothly occur.

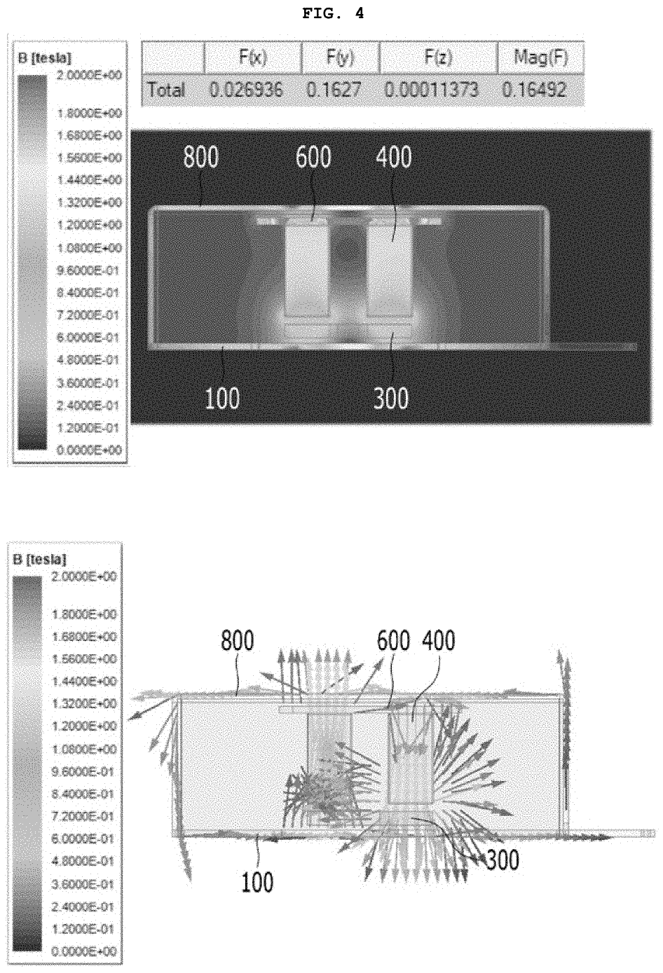

FIG. 4 is a diagram illustrating magnetic field distributions and magnetic field flows of the bracket and the case of the horizontal linear vibrating motor in accordance with the embodiment of the present disclosure.

In the present disclosure, the bracket 100 and the case 800 may be each made of a magnetic material to form one closed loop.

Referring to FIG. 4 illustrating the magnetic field distributions and the magnetic field flows, the magnetic fields of the bracket 100 are distributed in such a shape that the magnetic fields diffuse from the center of the bracket 100 to both sides, and the magnetic fields of the case 800 are also distributed in such a shape that the magnetic fields flow to the bottom along the sidewalls of the case 800 while diffusing from the top to both sides. Thus, one closed loop may be formed to maximize the electromagnetic field.

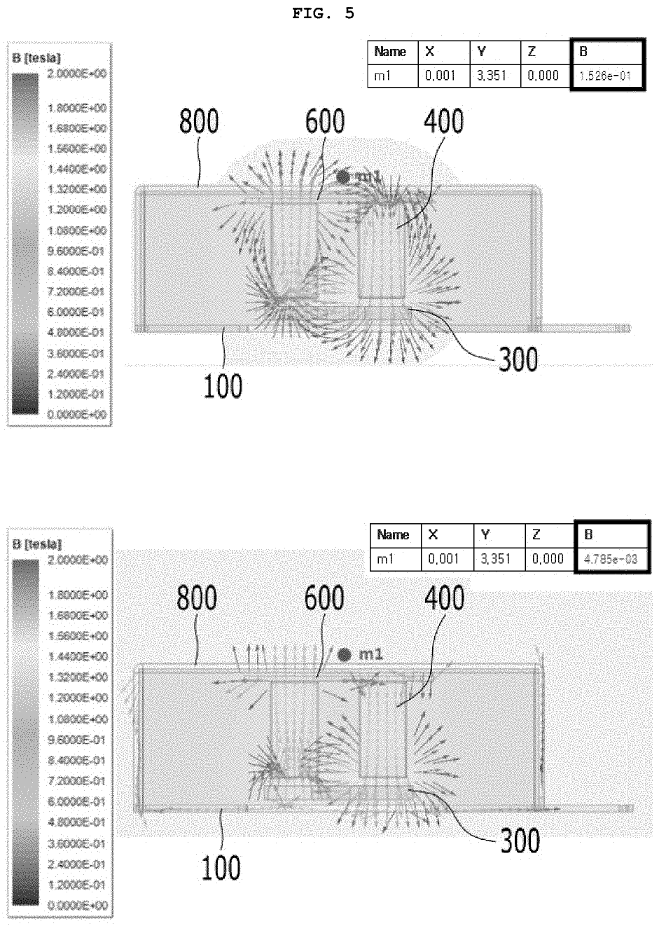

FIG. 5 is a diagram illustrating distributions and magnetic flux densities of a non-magnetic material and a magnetic material, which are applied to the bracket and case of the horizontal linear vibrating motor in accordance with the embodiment of the present disclosure.

In the present disclosure, the bracket 100 and the case 800 may be each made of a magnetic material to form one closed loop. As the magnetic material, ferrite-based SUS-430 or pure iron may be applied.

As shown in FIG. 5, (ml Point): 0.1526 [Tesla] 1526 Gauss when the non-magnetic material is applied, and (ml Point): 0.0047 [Tesla] 47.85 Gauss when the magnetic material is applied. That is, when the magnetic material is applied, it is possible to effectively shield leakage flux.

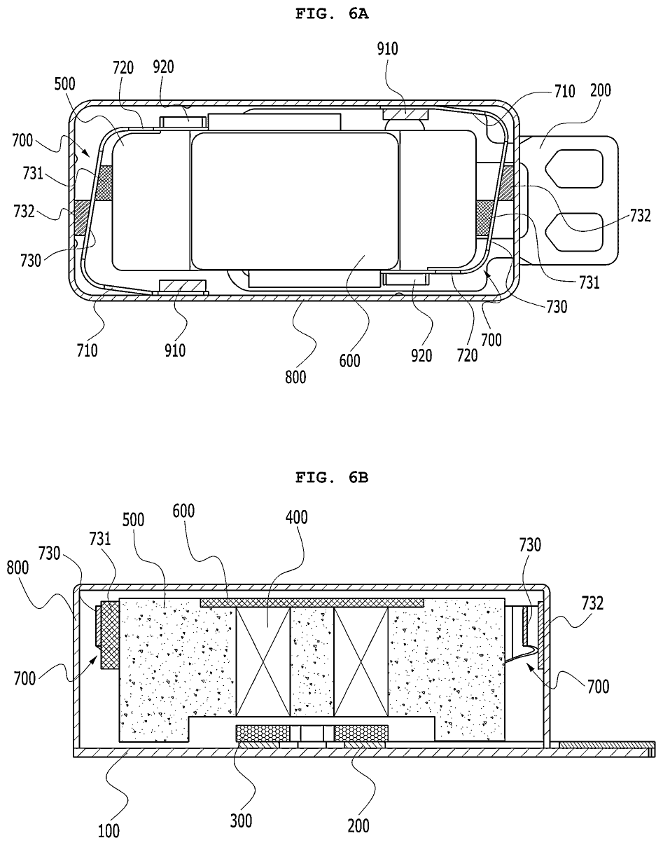

FIG. 6A is a transverse cross-sectional view illustrating a horizontal linear vibrating motor in accordance with another embodiment of the present disclosure, and FIG. 6B is a longitudinal cross-sectional view illustrating the horizontal linear vibration motor in accordance with the another embodiment of the present disclosure.

In the present disclosure, the third spring piece 730 located between the weight 500 and the case 800 has a simple shape. In addition to such a shape, however, the third spring piece 730 may include any one of an inner damper 731 abutting on the weight 500 on the inner side thereof and an outer damper 732 abutting on the case 800 on the outer side thereof, as illustrated in FIGS. 6A and 6B. This is in order to easily control a falling time.

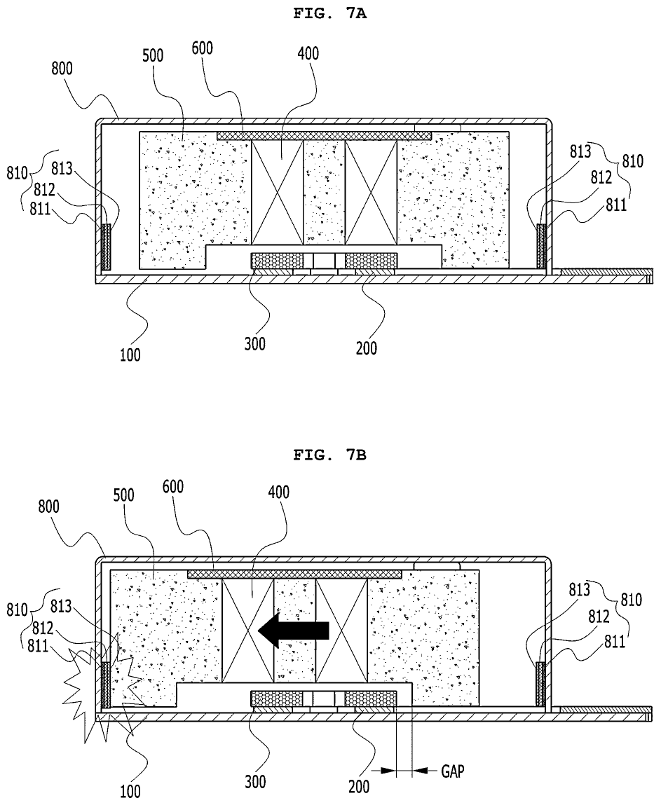

FIGS. 7A and 7B are longitudinal cross-sectional views illustrating the states of a horizontal linear vibrating motor in accordance with still another embodiment of the present disclosure, before and after a stopper type damper is operated.

In the present disclosure, the empty space is formed between the weight 500 and the case 800. In addition to such a shape, however, a stopper type damper 810 may be provided on the inside of the case 800 on the left/right side thereof, as illustrated in FIGS. 7A and 7B. In this case, a double-sided tape 811 is attached to one surface of the inner wall of the case 800, a PET film 812 is attached to the other surface of the double-sided tape 811, and PU foam 813 is provided on the PET film 812.

The horizontal linear vibrating motor having such a stopper type damper 810 is not affected during a normal operation, but is buffered by the PU foam 813 provided on the PET film 812 while the weight 500 is moved as indicated by an arrow of the FIG. 7B and bumps into the stopper type damper 810 in case of external shock, thereby preventing the deformation of the spring 700. Furthermore, between the coil 300 and the weight 500, a gap is formed to prevent damage to the coil 300.

While various embodiments have been described above, it will be understood to those skilled in the art that the embodiments described are by way of example only. Accordingly, the disclosure described herein should not be limited based on the described embodiments.

What is claimed is:

1. A horizontal linear vibrating motor comprising:
a bracket 100 form the exterior of the horizontal linear vibrating motor, and configured to fix an FPCB 200, and shield leakage flux;
the FPCB 200 seated on the top of the bracket 100 and configured to supply an external voltage to a coil 300;
the coil 300 provided on the FPCB 200, and configured to generate an electromagnetic field according to an external signal, and amplify horizontal vibration through an interaction with a magnet 400;
the magnet 400 provided as a permanent magnet, fixed to a plate 600, and configured to generate a magnetic field, and cause the weight 500 to horizontally vibrate from side to side, through an interaction with the magnetic field of the coil 300;
the weight 500 connected to a spring 700, configured to amplify vibration using the weight thereof and decide a resonance frequency, and having the plate 600 fixed thereto;
the plate 600 fixed to the weight 500, coupled to the magnet 400, and configured to form a magnetic field closed loop to concentrate magnetic fields;
the spring 700 connected to a case 800 and the weight 500, and configured to amplify vibration, and decide the resonance frequency;
the case 800 forming the exterior of the horizontal linear vibrating motor, and configured to protect the weight 500, fix the spring 700, and shield leakage flux; and
a support 900 configured to fix the spring 700,
wherein the spring 700 has a U-shape structure formed by a first spring piece 710, a second spring piece 720 and a third spring piece 730, wherein the first spring piece 710 is fixed to the inner surface of the case 800 by a first support 910 which protrudes from the top of the first spring piece 710 so as to have a predetermined height, and maintains the predetermined height when assembled to the case 800, the second spring piece 720 is fixed to the outer surface of the weight 500 by a second support 920 at the rear thereof so as to maintain a predetermined distance from the first spring piece 710, and the third spring piece 730 has a planar top, to which the first and second spring pieces 710 and 720 are connected, and an arch-shaped bottom,
wherein the first spring piece 710 is bent at a predetermined angle α toward the weight 500 from an end of the first support 910, such that a straight space S is provided to enable straight movement, wherein the angle α is set to 5° or more.
